(19) United States
(12) Patent Application Publication
(10) Pub. No.: US 2004/0017780 A1
(43) Pub. Date: Jan. 29, 2004

(54) Physical layer device with diagnostic loopback capability

(76) Inventors: Mehmet V. Tazebay, Irvine, CA (US); Mark Berman, Newport Coast, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/205,624

(22) Filed: Jul. 26, 2002

(51) Int. Cl. H04J 1/16

(52) U.S. Cl. 370/248; 370/249

(57) ABSTRACT

A physical layer communications device including a receiver connected to a physical channel. A transmitter is also connected to the physical channel. A selector reflects a packet received by the receiver from a remote sender over the physical channel back to the sender when the physical layer communications device is in a diagnostic mode.

### BACKGROUND OF THE INVENTION

1. Field of the Invention

The present invention relates to a diagnostic tool for testing operation of physical layer network devices.

2. Related Art

Conventional network communication involves the use of at least two physical layer devices communicating over a physical channel. Such physical layer devices are typically referred to as PHY devices, or simply PHYs. Each PHY normally needs a media access controller, or MAC, to which it interfaces, and which controls operation of the PHY.

Examples of a PHY include cable modems, network cards for LANs and WANs, cellular modems, etc. Examples of a physical layer include wire or wireless communications media, fiber optic lengths, WANs, etc.

In the course of developing a PHY device, it is often desirable to test its performance before the MAC is available. For example, the MAC may be not yet operational, may not be debugged, may be non-functional, etc. At the same time, it would be useful to be able to test operation of the PHY even without a MAC.

### SUMMARY OF THE INVENTION

The present invention is directed to a physical layer device with diagnostic loopback capability that substantially obviates one or more of the problems and disadvantages of the related art.

There is provided a physical layer communications device including a receiver connected to a physical channel. A transmitter is also connected to the physical channel. A selector reflects a packet received by the receiver from a remote sender over the physical channel back to the sender when the physical layer communications device is in a diagnostic mode.

In another aspect there is provided a physical layer communications device including a receiver connected to a physical channel and receiving packets. A transmitter is connected to the physical channel. A media access controller (MAC) interface is used for the physical layer communications device to operate under control of a MAC in normal operation. The physical layer communications device loops back the packets over the physical channel using the transmitter back to the sender in a diagnostic mode.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an overall architecture of the physical layer devices and media access controllers of the present invention; and

FIG. 2 illustrates additional detail of the structure of a physical layer device of the present invention.

### DETAILED DESCRIPTION OF THE INVENTION

Reference will now be made in detail to the embodiments of the present invention, examples of which are illustrated in the accompanying drawings.

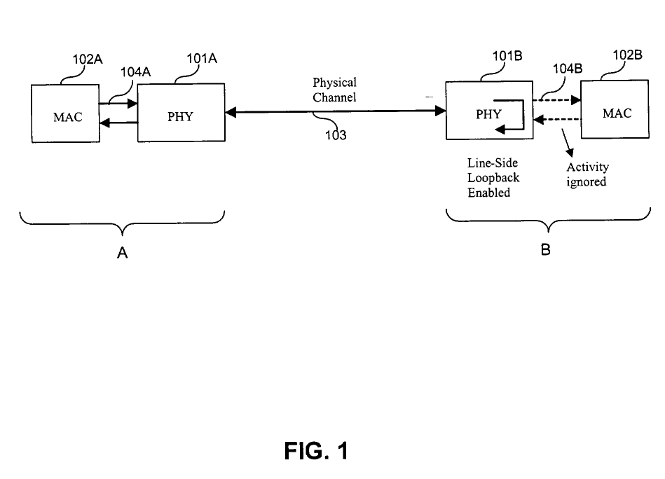

FIG. 1 illustrates the overall architecture of the present invention. Side A has a physical layer device 101A and its corresponding MAC 102A, connected to the PHY 101A using a MAC interface 104A, which controls operations of PHY 101A. PHY 101A is connected over a physical channel 103 to devices on side B, which include a physical layer device 101B, an optional MAC 102B and an optional MAC interface 104B. However, MAC 102B may be not enabled, not yet operational, or not yet fully debugged. Accordingly, there is a need for side A devices to be able to test operation of the physical layer device 101B on side B. In other words, there is a need for a diagnostic tool to test the physical layer device (in this case, PHY 101B), without the use of a MAC 102B. To accomplish this, PHY 101B has a mode of operation that allows it to reflect, or loop back, packets sent to it over the physical channel 103, so that side A devices can evaluate whether the physical layer device on side B, PHY 101B, operates properly. Side B physical layer device 101B can therefore complete the loop back operation without participation or need for MAC 102B.

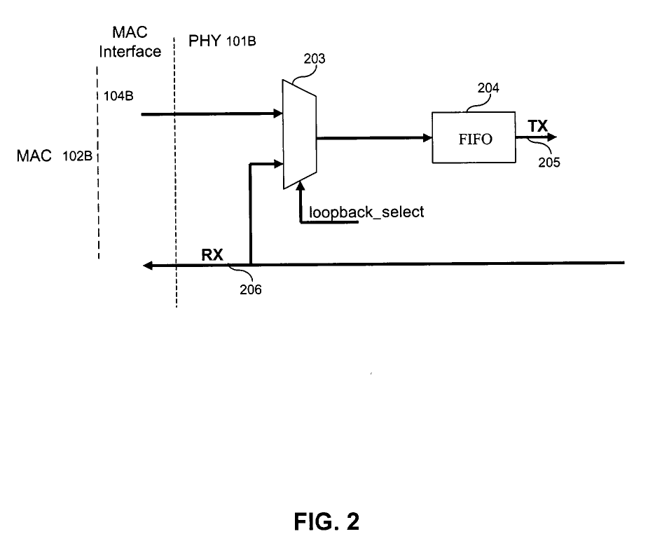

FIG. 2 shows one implementation of the present invention. As shown in FIG. 2, the physical layer device 101B includes a multiplexer 203, and a first-in-first-out (FIFO) structure 204. The multiplexer 203 is controlled by a loopback select signal. The physical layer device 101B is coupled to receive and transmit portions 206, 205, respectively of the physical channel 103.

With use of the multiplexer 203, a packet may be received over the transmit channel 205, stored in the FIFO 204, and reflected, or looped back to side A transmitting device, i.e., to physical layer device 101A. Thus, if the reflected packet is the same as the transmitted packet, side A knows that the physical layer device 101B on side B operates properly, even without the need for a fully tested or integrated MAC 102B.

The present invention is applicable to virtually any physical channel, such as wireless LANs, wireless WANs, fiberoptic networks, including fiberoptic LANs and WANs, Ethernet networks, cellular modems, DSL and ADSL lines, etc. Examples of physical layer device 101B to which the invention is applicable includes cable modems, DSL and ADSL modems, Ethernet network cards, and LAN and WAN transceivers.

Furthermore, although the embodiment above has been described in terms of receiving and re-transmitting a packet, a continuous data stream, such as seen in conventional telephone modems, can also be reflected back to the sending device. Furthermore, although the illustrated embodiment in FIG. 2 is implemented using a multiplexer, it is also possible to utilize an analog switch, provided signal integrity is preserved during reflection. In other words, in the case of Ethernet communication, there is a limitation on the distance between the transmitter and the receiver. Therefore, if an analog switch is used, it may be necessary to receive the signal (continuous or packet-based), regenerate the received signal, and transmit it back to the sender.

The multiplexer 203 (or the analog switch) can generally be referred to as a selector that reflects received data back to the sending device.

It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A physical layer communications device comprising:
a receiver connected to a physical channel;
a transmitter connected to the physical channel; and
a selector that reflects a packet received by the receiver from a remote sender over the physical channel back to the sender, using the transmitter, when the physical layer communications device is in a diagnostic mode.

2. The physical layer communications device of claim 1, wherein the selector is a multiplexer controlled by a diagnostic mode select signal.

3. The physical layer communications device of claim 2, further including a First In First Out (FIFO) structure for storing the packet prior to reflecting the packet back to the sender.

4. The physical layer communications device of claim 1, wherein the selector is an analog switch.

5. The physical layer communications device of claim 1, wherein the physical channel is a wireless network.

6. The physical layer communications device of claim 1, wherein the physical channel is a DSL line.

7. The physical layer communications device of claim 1, wherein the physical channel is a cable modem communications system.

8. The physical layer communications device of claim 1, wherein the physical channel is an fiberoptic network.

9. The physical layer communications device of claim 1, wherein the physical channel is an Ethernet network.

10. The physical layer communications device of claim 1, wherein the device is a modem.

11. The physical layer communications device of claim 1, wherein the device is an Ethernet card.

12. A physical layer communications device comprising:
a receiver connected to a physical channel for receiving packets from a sender;
a transmitter connected to the physical channel;
a media access controller (MAC) interface;
wherein the physical layer communications device operates under control of a MAC through the MAC interface in normal operation, and loops back the packets using the transmitter over the physical channel back to the sender in a diagnostic mode.

13. The physical layer communications device of claim 12, further including a multiplexer controlled by a diagnostic mode select signal that reflects the packets to the receiver in the diagnostic mode.

14. The physical layer communications device of claim 12, further including an analog switch and a regeneration circuit controlled by a diagnostic mode select signal that regenerates the packets and reflects the packets to the receiver in the diagnostic mode.

15. The physical layer communications device of claim 12, further including a FIFO structure for storing the packets prior to reflecting the packets back to the sender.

16. The physical layer communications device of claim 12, wherein the physical channel is a wireless network.

17. The physical layer communications device of claim 12, wherein the physical channel is a DSL line.

18. The physical layer communications device of claim 12, wherein the physical channel is a cable modem communications system.

19. The physical layer communications device of claim 12, wherein the physical channel is an fiberoptic network.

20. The physical layer communications device of claim 12, wherein the physical channel is an Ethernet network.

21. The physical layer communications device of claim 12, wherein the device is a modem.

22. The physical layer communications device of claim 12, wherein the device is an Ethernet card.

23. A physical layer communications device comprising:
a receiver connected to a physical channel that receives a data stream from a remote sender;
a transmitter connected to the physical channel; and
a multiplexer and a FIFO that reflect the data stream back to the sender using the transmitter when the physical layer communications device is in a diagnostic mode.
